(19) United States
(12) Patent Application Publication
(10) Pub. No.: US 2013/0305555 A1
(43) Pub. Date: Nov. 21, 2013

(54) BABA BUDDY BABY BOTTLE DRYING WAND

(71) Applicant: Lisa Spector, New York, NY (US)

(72) Inventor: Lisa Spector, New York, NY (US)

(21) Appl. No.: 13/860,441

(22) Filed: Apr. 10, 2013

Related U.S. Application Data
(60) Provisional application No. 61/686,675, filed on Apr. 10, 2012.

(51) Int. Cl. F26B 19/00

(52) U.S. Cl. CPC F26B 19/00
USPC 34/95.1

(57) ABSTRACT

The invention provides a bottle drying wand comprising a handheld wand tool including a disposable or reusable drying cloth and configured to easily dry infant and toddler baby bottles and sippy cups. The Baba Buddy comprises a drying wand tool wherein the base of the drying wand tool is a contoured and rounded handle to facilitate a comfortable grip. The distal end of the Baba Buddy culminates in a trident configuration having two elongated and tapered fork like tines positioned side by side. Centrally positioned between these rounded tines is a slightly shorter designed to attach and secure the drying cloth to the tool.

### CLAIM OF PRIORITY

This patent application claims priority under 35 USC 119(e) (1) from U.S. Provisional Patent Application Ser. No. 61/686,675 filed Apr. 10, 2012, of common inventorship herewith entitled, “Baba Buddy.”

### FIELD OF THE INVENTION

The present invention pertains to the field of infant and toddler accessories, and more specifically to the field of baby bottle utility accessories.

### BACKGROUND OF THE INVENTION

The prior art has put forth several designs for baby bottle utility accessories: Among these are:

U.S. Pat. No. 6,978,509 to Pai Yung Lin describes a cleansing device that includes a cleansing cloth having a base and a cover fabric layers superposed together, and a number of fibers disposed and secured between the base and the cover fabric layers. A handle is attached to the cleansing cloth to carry and operate the cleansing cloth. Each of the fabric layers include a number of strips to partially expose the fibers. An outer fabric layer is attached to the cover fabric layer to form one or more pockets and receive the handle. The handle includes a fork having two arms engageable into the pocket of the cleansing cloth and a hand grip foldably secured to the fork.

U.S. Pat. No. 7,260,862 to Tina DeFilippis describes a baby bottle and nipple cleaning apparatus having a plurality of interchangeable brush members that attach to an electrically operated handle that serves to oscillate or rotate the brushes to more effectively remove debris from the object being cleaned. Other brush attachments may be adapted for cleaning other objects such as dishes and the like. Apparatus is available in any number of colors such as child friendly soft pastels. Decorative figures such as teddy bears, clowns and cartoon characters adorn the handle or charger.

U.S. Pat. No. 7,383,602 to Yoshinori Tanaka and Akemi Tsuchiya describes a device for holding a cleaning wiper that includes a synthetic resin body portion bifurcated to have a pair of support plates inserted into a tube of the wiper and a handle portion extending from the body portion to be held by hand. Each support plate is in an elongated plate form having a width larger than a thickness. The paired support plates extend parallel with each other to have inner side edges facing each other and outer side edges facing in opposite directions. Protrusions having convexly curved edges are integrally formed on the respective outer side edges of the support plates. The paired support plates are elastically deformable to permit tip ends thereof to approach each other.

None of these prior art references describe the present invention.

### SUMMARY OF THE INVENTION

It is an object of the present invention to provide a simple and efficient hand held wand tool to accommodate a disposable drying cloth that will thoroughly dry the interior surface of a bottle, such as a baby bottle, sippy cup or other bottle.

It is a further object of the present invention to provide a simple and efficient hand held wand tool to accommodate a reusable cloth that will thoroughly dry the interior surface of a baby bottle, sippy cup or other bottle.

### BRIEF DESCRIPTION OF THE DRAWINGS

FIG. 1 is a top diagonally perspective view showing a hand held wand with a plastic top fork and tongue for securing a disposable or reusable drying cloth to the wand.

FIG. 2 is a top down perspective view showing a drying cloth having sleeves for receiving the tines of the wand to secure the disposable or reusable drying cloth onto the wand by sliding the tines into the sleeves.

FIG. 3 is a top down diagonal perspective view showing the sleeves of the disposable or reusable drying cloth positioned onto the tines of the wand and ready for use.

FIG. 4 is front functional view of a hand held wand tool with disposable or reusable drying cloth attached to the wand inserted into the inside of a baby bottle ready for a user to grip the handle and rotate the cloth around the inside of the baby bottle for thorough and effective drying.

FIG. 5 shows an alternative embodiment wherein the central tongue is longer than the tongue in the embodiment shown FIGS. 1 and 3 and the tines each terminate in a perpendicular foot to secure the drying cloth onto the device and to completely clean the corner of the bottle where the bottom of the bottle meets the side wall of the bottle.

FIG. 6 shows a further alternative embodiment wherein the central tongue is longer than the embodiment shown in FIGS. 1 and 3 and features a serrated or saw toothed gripping surface on the tongue to secure the drying cloth onto the device.

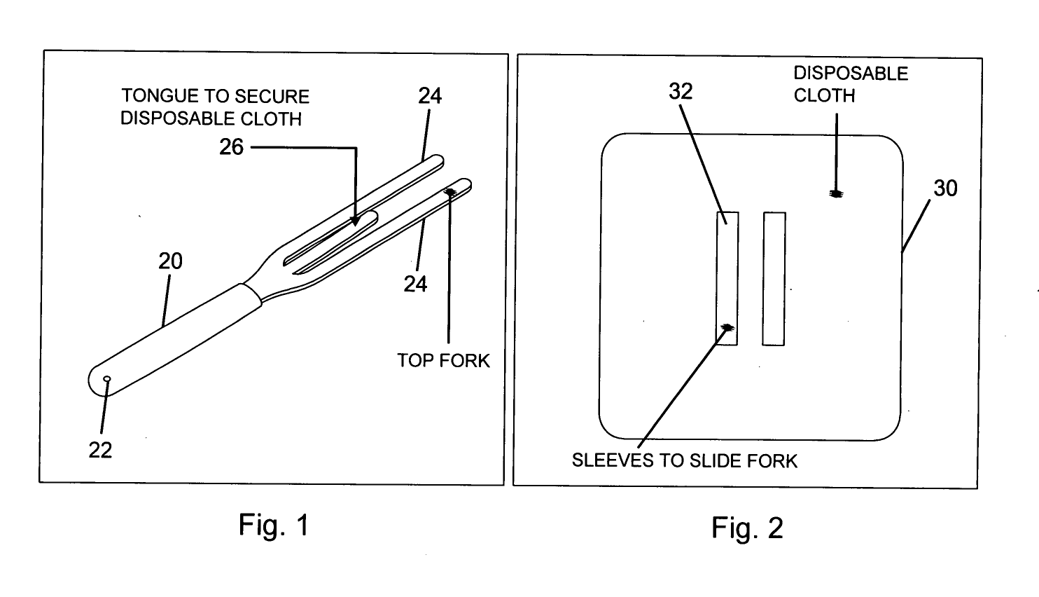

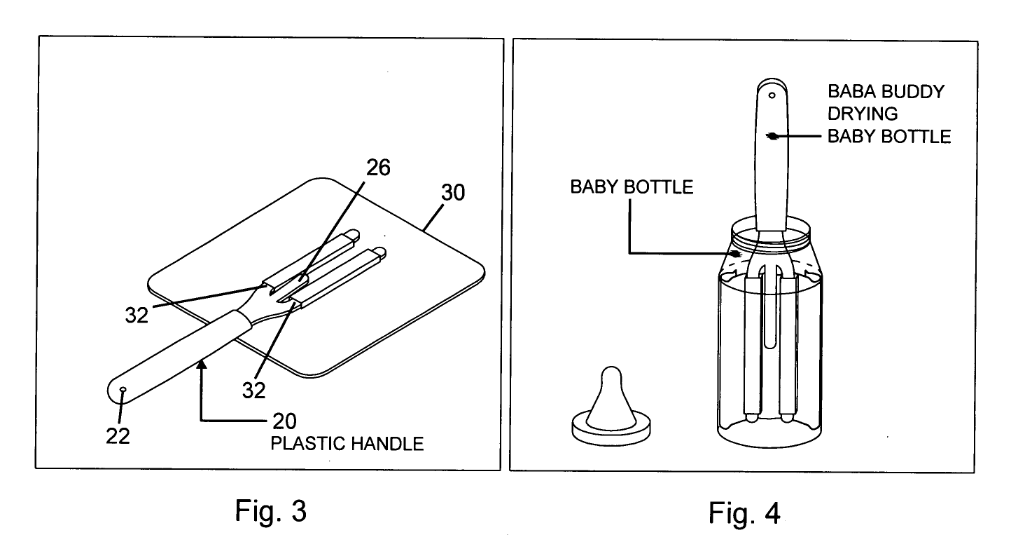

### DETAILED DESCRIPTION OF THE INVENTION

For most parents of babies or toddlers, a baby bottle is must have item. Baby bottles provide nourishing milk to an infant and help to soothe a baby who is fussy or colicky. A baby bottle is used by many nursing mothers to feed their child when traveling or in public. From a child's sole nourishment at time of birth and infancy to a nutritional supplement or snack during toddler years, a bottle of warm milk is essential for a healthy happy child While a baby bottle is a practical necessity in most households with infant children, cleaning and drying that baby bottle in a practical way is a difficult endeavor. Parents or caretakers typically utilize bottle brushes to whisk away milk or juice residue from within a baby bottle. Many people sterilize baby bottles in boiling water to ensure all lingering germs and bacteria are eradicated. Once the bottle is cleaned, most conscientious caregivers take an extra step of thoroughly drying the bottle prior to filling it with formula or another beverage. Drying a baby bottle is frustrating and inefficient. Shoving a dishtowel deep inside a baby bottle in awkward attempts to remove water residue from interior walls of a bottle is a time consuming hassle. An alternative method of allowing a bottle to air dry is a slow process that may take hours to complete and keeps countertops constantly cluttered with a dozen slowly drying baby bottles. Air drying also allows germs to land and accumulate on the surface of the bottle.

The present invention, Baba Buddy Baby Bottle Drying Wand, hereinafter also referred to as the Baba Buddy, is a specially designed handheld wand tool including disposable or reusable drying cloth coverings and configured to easily dry infant and toddler baby bottles and sippy cups. The Baba Buddy provides consumers a simple, efficient and sanitary means of thoroughly drying their infant and toddler baby bottles and sippy cups prior to filling them with formula, juice or other beverages. The Baba Buddy is configured specifically to enable one to thoroughly dry the interior of a baby bottle in mere seconds. The Baba Buddy comprises a drying wand tool on which super absorbent disposable or reusable drying cloths are easily attached. The drying wand tool is a handheld wand instrument manufactured of BPA-free plastic material. Elongate and rectangular in shape, this contoured hand held tool measures approximately eleven inches in total length. The base 20 of the drying wand tool is a contoured and rounded handle to facilitate a comfortable grip. A circular hole 22 is positioned at the base of the wand tool for easily hanging the present invention from any utensil rack. The distal end of the Baba Buddy culminates in a trident configuration having two elongated and tapered fork like tines 24 positioned side by side. Each tine 24 measures approximately five inches in length and one quarter inch in width. Centrally positioned between these rounded tines at the base of each tine is a slightly shorter tongue like protrusion, or tongue 26, designed to attach and secure the drying cloth 30 to the tool.

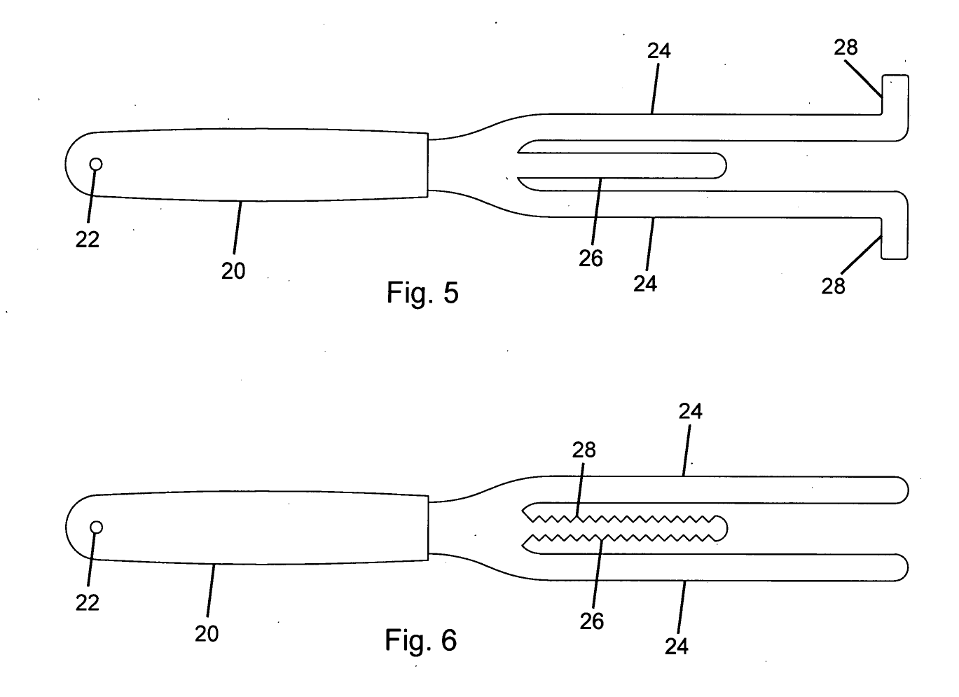

Alternative embodiments are shown in FIGS. 5 and 6 The embodiment in FIG. 5 features feet 28 at the end of the tines which feet extend perpendicularly outward away from the central axis of the device. These feet 28 are intended to help secure the cloth 30 onto the wand and also to more completely access and clean the corner of the bottle where the bottom of the bottle meets the side wall of the bottle.

FIG. 6 shows the preferred embodiment of the present invention. In this embodiment, the central tongue 26 features a serrated or saw toothed gripping surface 28 to secure the drying cloth 30 onto the device. The serrated tongue 26 is square or rectangular in cross-section. The cross-section configuration of the tines 24 are oval or circular.

Drying cloths used in conjunction with the Baba Buddy are approximately square shaped units manufactured of super absorbent sanitary paper material. Alternatively the drying cloth can be washable and reusable and can be made of any suitable material, such as a polyamide polyester, or cotton or cotton blend, for example. If disposable, the cloth is bio-degradable, hypoallergenic and fragrance free. The size of the cloths can be any appropriate size suitable for the purpose of drying the bottle. A square or rectangular cloth is envisioned. One example of a suitable sized cloth measures approximately four inches in length by four inches in width. The cloth 30 comprises of side by side fitted sleeves, positioned near the base of the cloth and appropriately sized to accommodate the tines of the Baba Buddy drying tool. Several drying cloths are included initially with the Baba Buddy. Replacement cloths packaged in multi count containers are available for purchasing separately from the Baba Buddy and sold along side the unit.

Use of the Baba Buddy is very simple and straight forward. This device is utilized in conjunction with virtually any plastic or glass infant or toddler baby bottle or sippy cup. First, the user washes and sterilizes all baby bottles as usual. The user then utilizes the Baba Buddy to quickly dry the interior of each bottle. Grasping the Baba Buddy in hand, the user slides a drying cloth over the tines of the unit, aligning the tines of the tool with the fitted sleeves incorporated into the design of the cloth. With each tine ensconced within the appropriate sleeve, the user secures the base of the cloth beneath the Baba Buddy's tongue further securing the cloth in place. Next, the user inserts the inverted Baba Buddy into the baby bottle, allowing the attached cloth to quickly absorb water on contact. After swiping the cloth over the interior walls of the bottle, the user removes the Baba Buddy from the now perfectly dry bottle. The user repeats this drying process with remaining washed bottles. As needed, the saturated cloth is removed, discarded or laundered and replaced with a fresh dry Baba Buddy drying cloth. After use, the Baba Buddy is stored until needed again.

The Baba Buddy is a unique invention which offers consumers a number of significant benefits and advantages. Foremost, the Baba Buddy provides consumers a simple and efficient means of thoroughly drying baby bottles. Featuring disposable or reusable super absorbent drying cloths which are easily attached to an elongated and ergonomic handle, the Baba Buddy quickly eradicates all lingering water from within the bottle, even water pooled on the very bottom of the bottle. Enabling users to thoroughly dry a baby bottle or sippy cup, the Baba Buddy proves to be an invaluable health and safety tool, protecting an infant from exposure to harmful germs and bacteria lingering in the water residue. Easily manipulated inside the bottle, the Baba Buddy enables the user to remove excess water in a quick and easy manner without struggling with hand towels and other instruments to manipulate the hand towel. Eliminating countertops cluttered with slowly air drying baby bottles, the Baba Buddy is a favorite accessory in homes with parents and babies. A practical and invaluable kitchen accessory that is highly efficient and effective, the Baba Buddy may function as a favorite commodity in any household. In addition to household use, the Baba Buddy functions well for child care providers and professional nannies in day care establishments; hospital nurseries, pediatric wings, paramedic units, military families moving from base to base, world relief agencies, orphanages, and any facility the would make use of the Baba Buddy.

Additionally, the present invention can be useful for drying any bottle, vase, jar or other receptacle, which presents an opening too narrow to fit a human hand.

The Baba Buddy can also be used as a promotional product for manufacturers of baby bottles and accessories. Because the user is unable to get their hand inside the baby bottle, the Baba Buddy will be an essential and invaluable tool to dry the inside of a baby bottle and keep it germ free. Durably constructed of quality materials, the Baba Buddy will withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A bottle drying device comprising: a hand held wand configured to accommodate a drying cloth that will allow thorough drying of the interior surface of a baby bottle, comprising:
an elongate drying wand tool having a proximal end and a distal end and comprising a contoured and rounded handle to facilitate a comfortable grip at its proximal end, further comprising
a trident configuration at the distal end wherein the trident configuration comprises two elongated and tapered fork like tines positioned side by side and a tongue in between the tines.

2. The bottle drying device of claim 1, further comprising:
an absorbent disposable or reusable drying cloth having sleeves for receiving the tines of the wand wherein the cloth is secured to the wand by sliding the tines into the sleeves and positioning the tongue over the cloth.

3. The bottle drying device of claim 2, further comprising a circular hole positioned near the proximal end of the wand for easily hanging the device.

4. The bottle drying device of claim 3, wherein the device is manufactured of BPA-free plastic material.

5. The baby bottle drying device of claim 3, wherein the device measures approximately eleven inches in total length and the tines measure approximately five inches in length, and the tongue measures approximately three inches in length.

6. The bottle device of claim 3 wherein the tines terminate in feet at the end of the tines which feet extend perpendicularly outward away from the central axis of the device.

7. The bottle device of claim 3 wherein the tongue features a serrated or saw toothed gripping surface to secure the drying cloth onto the device.

8. The bottle device of claim 7 wherein the serrated tongue is square or rectangular in cross-section, and the cross-section configuration of the tines are oval or circular.

9. The bottle drying device of claim 2 wherein the drying cloth is approximately square shaped and manufactured of super absorbent sanitary paper material.

10. The bottle drying device of claim 2 wherein the drying cloth can be washable and reusable and can be made of any suitable material.

11. The bottle drying device of claim 10 wherein any suitable material includes polyamide polyester, polyester, cotton, and cotton blend.

12. The bottle drying device of claim 9, wherein the cloth is bio-degradable, hypoallergenic and fragrance free.

13. The bottle drying device of claim 2, wherein the cloth measures approximately four inches in length by four inches in width, and wherein the cloth comprises side by side fitted sleeves positioned near the base of the cloth appropriately sized to accommodate the tines.

14. The bottle device of claim 3 wherein the tines terminate in feet at the end of the tines which feet extend perpendicularly outward away from the central axis of the device and wherein the tongue features a serrated or saw toothed gripping surface to secure the drying cloth onto the device.
